(19) United States
(12) Patent Application Publication
(10) Pub. No.: US 2009/0277188 A1
(43) Pub. Date: Nov. 12, 2009

(54) Heat Exchanger for a Mobile Refrigerated Vehicle

(75) Inventors: Dirk Teegen, Hamburg (DE); Franz Lurken, Franz (DE); Helmut Henrich, Pulheim (DE); Reinhard Kost, Krefeld (DE)

Correspondence Address: AIR LIQUIDE;Intellectual Property, 2700 POST OAK BOULEVARD, SUITE 1800, HOUSTON, TX, 77056, US

(73) Assignee: L'Air Liquide Societe Anonyme Pour L'Etude Et L'Exploitation Des Procedes Georges Claude, Paris (FR)

(21) Appl. No.: 12/296,399

(22) PCT Filed: Mar. 28, 2007
(86) PCT No.: PCT/IB2007/051446

§ 371 Date: Jan. 12, 2009

(30) Foreign Application Priority Data
Apr. 7, 2006 (DE) 102006016559.4

(51) Int. Cl. F17C 1/00; F25B 39/02; F28F 13/12; F24H 1/10

(52) U.S. Cl. 62/50.2; 62/515; 165/109.1; 62/50.5; 392/480

(57) ABSTRACT

The invention relates to a heat exchanger for a mobile refrigerated vehicle having a tank for liquefied gas comprising a pipe for accepting a flow of a liquefied gas and for the evaporation of at least one part of the liquefied gas, in conjunction with which the pipe, at least in sections, exhibits a longitudinal axis, and the heat exchanger comprises an inlet side for liquefied gas and an outlet side for at least partially evaporated gas, and in conjunction with which the outlet side is connected to an exhaust pipe in such a way as to permit a flow, in conjunction with which the pipe exhibits elements in its interior for the purpose of generating turbulences in the flow or a radial phase separation. The invention is characterized in that, with the help of the elements, the thickness of a gas interface layer on a wall of the pipe, which occurs as a result of vaporization of the gas, is reduced considerably, whereby the efficiency of the heat exchanger is increased considerably.

The invention relates to a heat exchanger for a mobile refrigerated vehicle having a tank for liquefied gas comprising a pipe for accepting a flow of a liquefied gas and for the evaporation of at least one part of the liquefied gas, in conjunction with which the pipe, at least in sections, exhibits a longitudinal axis, and the heat exchanger comprises an inlet side for liquefied gas and an outlet side for at least partially evaporated gas, and in conjunction with which the outlet side is connected to an exhaust pipe in such a way as to permit a flow.

For approximately 30 years, nitrogen has been used for the refrigeration of vehicles with multi-chamber systems. A method of this type is already familiar under the name CryogenTrans (CT). The CT method involves carrying nitrogen in liquid form at low temperature in a vacuum-insulated container on or in the vehicle. As and when cooling is required, this nitrogen is drawn off via a pipe and is sprayed directly into the chamber to be refrigerated by the inherent pressure of the medium. The method is particularly simple and is immune to interference. What is more, the refrigerating capacity is always at the same level regardless of the ambient temperature. It is restricted in principle only by the flow capacity of the spray nozzles. As a consequence of this, CT refrigerated heavy goods vehicles, which are used in foodstuffs distribution and by their nature have numerous door openings during refrigerated operation, exhibit considerable advantages in respect of the quality of the refrigeration. In particular in the height of the summer, when mechanical refrigeration plants have to struggle with reduced performance of their condensers and with icing-up of their evaporators, the CT method demonstrates its advantages in terms of efficiency, dependability and performance. After opening a door, it takes only seconds for the reference temperature to be achieved once again.

The method also has its disadvantages, however. The consumption of nitrogen is relatively high, because at least some of the gas sprayed into a chamber also escapes again as exhaust gas. If, for example, a frozen food chamber is refrigerated, the temperature of the exhaust gas will be in the order of −30 to −40° C. The fact that a load space needs to be fully ventilated for reasons of safety before being entered is also disadvantageous. An unnecessarily large quantity of warm air enters the load space in this case. Although the renewed reduction in temperature admittedly takes place very rapidly, it consumes more energy and as a result incurs more costs than necessary. The otherwise customary installation of cold retention systems, such as a curtain, is inappropriate in the case of CT refrigerated vehicles, because they would impair the ventilation in a dangerous manner.

EP 0 826 937 A describes a refrigeration unit for a chamber to be refrigerated.

EP 1 593 918 A relates to an indirect means of refrigeration for refrigerated vehicles, in which a heat exchanger is arranged for the vaporization of low-temperature liquefied gas in a refrigerated chamber.

Liquefied low-temperature nitrogen has a temperature of 77° K. under normal pressure. The cold that is stored in this case is present as two components: on the one hand as a component that is liberated during the phase transition from liquid to gaseous at a temperature of 77° K., and on the other hand as a component that absorbs heat in conjunction with heating of the gaseous phase from 77° K. up to the exhaust gas temperature. The two components, enthalpy of vaporization and specific heat, are of approximately the same size as a rule.

When using liquefied low-temperature nitrogen as a refrigeration medium, particular characteristics are required of the heat exchangers. As a result of the large differences in temperature between the heat exchanger temperature and liquid nitrogen at −196° C., considerable thermally induced stresses occur in the material in conjunction with cooling of the heat exchanger.

The object of the present application is to make available a heat exchanger, which combines a high heat exchange efficiency, operating reliability and dependability with the most compact construction possible.

This object is achieved by the subject-matter as defined in the independent claim. Additional advantageous embodiments and aspects, which in each case can be utilized individually or combined with one another as required in an appropriate manner, are indicated in the following description and in the dependent claims.

The heat exchanger according to the invention for a mobile refrigerated vehicle having a tank for liquefied gas comprises at least one pipe for accepting a flow of a liquefied gas and for the evaporation of at least one part of the liquefied gas, in conjunction with which the pipe, at least in sections, exhibits a longitudinal axis, and the heat exchanger comprises an inlet side for liquefied gas and an outlet side for at least partially evaporated gas, and in conjunction with which the outlet side is connected to an exhaust pipe, the pipe exhibiting elements in its interior for the purpose of generating turbulences in the flow.

As an alternative hereto, the heat exchanger according to the invention for a mobile refrigerated vehicle having a tank for liquefied gas comprises at least one pipe for accepting a flow of a liquefied gas and for the evaporation of at least one part of the liquefied gas, in conjunction with which the pipe, at least in sections, exhibits a longitudinal axis, and the heat exchanger comprises an inlet side for liquefied gas and an outlet side for at least partially evaporated gas, and in conjunction with which the outlet side is connected to an exhaust pipe, the pipe exhibiting elements in its interior for the purpose of producing a radial separation of the liquid phase and the gaseous phase.

An arrangement is preferred in this case, in which the liquid is forced against the external wall of the pipe and the gas is able to flow in the interior, as a result of which the transmission of heat on the outside and the gas flow on the inside are improved.

The heat exchanger is particularly suitable for the vaporization of liquefied gases and for utilizing the quantity of cold contained therein in a particularly efficient way. The heat exchanger exhibits a particularly high efficiency and operates in a particularly dependable manner.

In particular gases with boiling temperatures below −100° C., such as liquid nitrogen, can be used as liquefied gas. However, gases with higher boiling points, such as liquid carbon dioxide, can also be used subject to appropriate adaptation of the heat exchanger.

The gas is in particular cryogenically liquefied and is present in the tank at a pressure of about 1 bar to 20 bar absolute, and preferably between 1.5 bar and 3.5 bar. The tank is thermally insulated, for example by vacuum insulation or by enclosure in a foam jacket. The tank is connected in a fluid-conducting manner to the heat exchanger. The pipe for liquefied gas from the tank to the evaporator is advantageously thermally super-insulated.

Inside the heat exchanger, the liquefied gas is at least partially vaporized, and the amount of cold contained in the liquefied gas is given off to a refrigerated chamber in the mobile refrigerated vehicle. The refrigeration system in question is open and does not exhibit a closed circuit. A compressor for compressing the gas is not required, because the refrigeration system operates without the need for a compressor.

The pipe can be rectilinear, curved, meandering, wound in the form of a coil or folded in segments. The pipe can also be flat, undulating or star-shaped in its cross section. A flat pipe exhibits a cross-sectional width that is very much greater than the cross-sectional height. The expression cross section is understood here to denote a section through the pipe on a plane perpendicular to a longitudinal direction or to a longitudinal axis of the pipe. The pipe consists in particular of a material having good thermal conductivity properties, such as aluminium or copper, there being a preference for copper. Because of the low temperature and the associated steep temperature gradients and potential temperature fluctuations over time, a uniform material pairing of the components used for the heat exchanger is advantageous in order to reduce thermally induced material distortion and associated material fatigue phenomena.

The liquefied gas is vaporized at least partially inside the heat exchanger. The cold content released in conjunction with this is transported via refrigerant pipes by means of a cold transport medium, such as a cooling liquid or cooling air, to a desired point (e.g. in the interior of a refrigerated chamber). A refrigerated chamber on a refrigerated vehicle is then not cooled directly, but indirectly, by the liquefied gas.

Advantageously, the heat exchanger exhibits flow channels for cooling air for cooling, which, after cooling, is blown into a refrigerated chamber of the refrigerated vehicle. The heat exchanger exhibits in particular a ventilator for the purpose of recirculating the cooling air. The cooling air is advantageously blown against the pipe, in order to cause particularly intensive thermal contact between the cooling air and the pipe and thus between the cooling air and the liquefied gas.

In order to improve the transfer of cold, it is proposed that the pipe should exhibit elements in its interior for the purpose of generating turbulences in the flow or for the radial separation of liquefied and vaporized gas. With the help of these elements, vortices and turbulences are produced in the liquefied gas as it flows through the pipe. It has emerged that, with the help of these elements, the thickness of a gas interface layer on the wall of the pipe, in particular the thickness of a gas layer between the liquefied gas and the wall of the pipe, can be reduced considerably, and the cold contact, that is to say the refrigerating capacity, can be improved significantly.

The elements can be formed by baffles in the pipe, and in particular by profile rods or profile strips extending along the longitudinal axis. The baffles can also be formed by projections, protrusions or other partition walls or dividing walls, which project into the interior of the pipe and divide up or separate the internal cross section of the pipe.

The profile rods or profile strips can be of star-shaped execution, in particular with at least two jets, and preferably with at least three jets, for example at least 5 jets. A subdivision of the interior of the pipe into at least two, at least three or at least five gas supply channels is assured in this way.

The transmission of cold can also be improved through contact of the liquefied gas with the baffles and a subsequent transmission of cold between the baffles and the wall of the pipe. It is advantageous for this purpose if the baffles are attached to the pipe wall in such a way as to afford good thermal conductivity. For example, the baffles can be soldered or welded to the wall of the pipe. It is possible, alternatively or additionally, to use a material having low-temperature thermal expansion characteristics below those of the surrounding pipe, so that the latter shrinks onto the baffle.

It is particularly advantageous if the baffles extend in a transposed manner along the longitudinal axis. For example, a profile rod is transposed at least two times, in particular at least four times, and not more than 100 times, and in particular not more than 20 times per metre. The transposition of the pipe produces centrifugal acceleration of the liquefied gas while this is flowing through the pipe, as a result of which the thickness of the gaseous layer arising between the liquefied gas and the wall of the pipe due to vaporization is reduced considerably.

The baffles extend advantageously in an undulating manner along the longitudinal axis. Wavelengths for the undulations from 0.5 mm to 200 mm, and in particular from 1 mm to 10 mm, are advantageous in this case. The undulations cause turbulences in the flow as the liquefied gas flows through the pipe. The component of the vaporized gas in relation to the component of the remaining unvaporized gas is increased considerably by the elements for generating turbulences in the flow or for the radial separation of liquefied and vaporized gas.

The elements also contribute to a reduction in the thicknesses of the interface layers in relation to the already vaporized gas, as a consequence of which the liberation of the cold stored in the form of the low temperature of the gas in gaseous form is improved.

The pipe advantageously exhibits a pipe wall, and the pipe wall is profiled in particular along the longitudinal axis and is in particular undulating or transposed. Through profiling of the pipe wall of this kind, turbulences in the flow are also brought about in the interior of the pipe, which improve the efficiency of the heat exchanger.

The transposition amounts to at least two, and in particular at least four twists per metre. However, it should not exceed more than 100, in particular not more than 50, and in particular not more than 20 twists per metre, in order not to obstruct the free flow in the pipe.

The wavelength of the undulations, that is to say the distance in the longitudinal direction of the pipe from one wave crest to a neighbouring wave crest, is at least 0.5 mm, and in particular at least 1 mm. The wave length is not more than 200 mm, and in particular not more than 10 mm. An intimate thermal contact and cold contact is produced between the liquefied gas and the vaporized gas and the cold transport medium, for example cooling air, by the transposition and the undulations.

The pipe exhibits in particular an internal pipe cross section which changes along the length of the pipe. For example, the surface of the projection of a first internal pipe cross section at a first pipe location onto a second internal pipe cross section at a second pipe location is smaller than 90%, and in particular smaller than 70%, and preferably smaller than 50% of the surface of the internal cross section of the pipe. In this case, the two pipe locations are situated in particular at a distance of 100 mm from one another.

Turbulences in the flow in the pipe are generated by the change in the internal cross section of the pipe. The internal cross section of the pipe in this case can remain essentially constant along a longitudinal direction of the pipe. Turbulences are generated by the change in the form of the surface of the cross section in the longitudinal direction of the pipe. For example, the internal cross section of the pipe is oval or rectangular and is transposed in the form of a helical line in the longitudinal direction. The wall of the pipe can also exhibit a large number of impressions or depressions, which have a corresponding influence on the flow behaviour inside the pipe. The flow inside the pipe can exhibit a Reynolds number of at least 1,000, and in particular at least 2,000, for example 5,000.

A deflection of the liquefied gas in the pipe in the course of its flow through the pipe is produced by a small part of the surface of the internal pipe cross sections that are projected onto one another at the two pipe locations on the entire surface of the internal cross section of the pipe, which improves the thermal contact between the liquefied gas and the vaporized gas and the wall of the pipe.

Advantageously, the pipe exhibits rolled-out fins in particular on its outside. With the help of the fins, the cold absorbed by the wall of the pipe can be effectively liberated to the cold transport medium, for example to the cooling air for cooling. With the help of the fins, the surface of the pipe is enlarged considerably on its outside. The fins can run around the periphery in the form of a screw and/or can be undulating in form. By imparting an undulating structure to the fins, in addition to obtaining a larger surface per unit of volume, additional turbulences are generated, which improve the liberation of cold to the cold transport medium.

The pipe and the elements are produced advantageously from a homogeneous material, in particular copper, and/or are welded or soldered in particular. In the case of welding or soldering, an internal thermal contact is produced between the elements and the pipe, which improves the transfer of cold from the elements onto the pipe and, in so doing, increases the overall efficiency of the heat exchanger. In the same way, the fins on the outside of the pipe can be welded or soldered to it.

The elements divide in particular a cross section of the pipe into at least two, and in particular at least three, and preferably at least five internal cross sections of the pipe. In this way, a correspondingly large number of fluid channels is created inside the pipe, as a result of which the proportion of the surface of the pipe wall as a whole to the pipe volume is increased. In this way, the efficiency of the heat exchanger is increased.

It is advantageous if the internal cross sections of the pipe broaden radially towards the outside. Any centrifugal acceleration brought about by transposition of the pipe or the profile rods can be utilized by broadening from the inside radially towards the outside. The thickness of the interface layer between the wall of the pipe and the liquefied gas or the vaporized gas can be reduced in this way.

In a special arrangement, a phase separator is provided for the purpose of separating liquefied gas from the evaporated gas, which is connected to the outlet side of the heat exchanger in such a way as to permit a flow. With the help of the phase separator, the liquid part of the liquefied gas remaining unvaporized after passing through the heat exchanger can be drawn off and returned to the heat exchanger. The efficiency of the cold contained in the liquefied gas is increased in this way. The phase separator can be embodied as a pressure vessel. The inlet side for the liquefied gas can be arranged in particular above the outlet side for the at least partially evaporated gas. In this way, advantageous flow characteristics are achieved for the liquefied gas and for the cold transport medium.

The heat exchanger can exhibit a resistance heating means wrapped in the form of a helix around the pipe. Icing-up of the heat exchanger can be eliminated with the help of the resistance heating means. The resistance heating means can be in the form of a current-carrying wire enclosed by an insulating layer, which wire is wound around the pipe.

A catch tank can be provided underneath the pipe. In the particular case of the defrosting of any ice that has formed on the heat exchanger, the catch tank catches the defrosted water and leads it away from the heat exchanger. An additional heating element can be provided on the catch tank in order to accelerate the defrosting of any ice.

The heat exchanger can exhibit a heat exchanger housing manufactured in particular from thermoplastic material, which provides the air supply inside the heat exchanger. A particularly compact design and economical manufacture of the heat exchanger are possible in this way.

The heat exchanger advantageously exhibits a discharge opening, which exhibits arresting edges to catch drops of water. With the help of the arresting edges, which can be formed by a labyrinth passage, arresting skirts or other retaining plates, meltwater is prevented from being carried away from the heat exchanger together with the refrigerated cooling air. The flow channels for the cooling air are prevented in this way from becoming iced-up.

At least one pressure sensor on the heat exchanger and a means for testing the gas tightness of the cooling system, and in particular of the heat exchanger, are provided advantageously. This means can be used to establish whether any leaks in relation to the liquefied gas are present in the pipe system. A section of the pipe is closed for this purpose and is subjected to a positive pressure, and the stability of the positive pressure is then observed. It can be expedient to provide temperature sensors in addition to the pressure sensors. By taking a temperature measurement, it is possible to ensure that no liquid gas, which could distort the pressure measurement through vaporization, remains present in the part of the pipe system to be tested.

A temperature sensor is advantageously provided on the heat exchanger and is connected electrically to the means for testing the gas tightness.

Further advantageous aspects and further developments, which can be utilized individually or can be combined with one another in a suitable manner, as required, are explained on the basis of the following drawing, which is intended not to restrict the invention, but only to illustrate it by way of example.

The drawing contains schematic representations of:

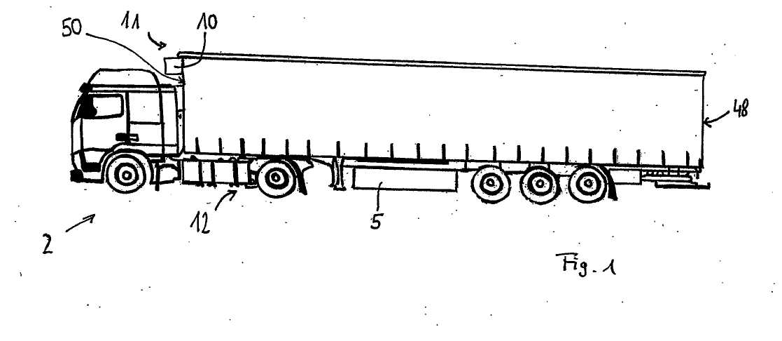

FIG. 1 a refrigerated vehicle according to the invention depicted schematically as a side view;

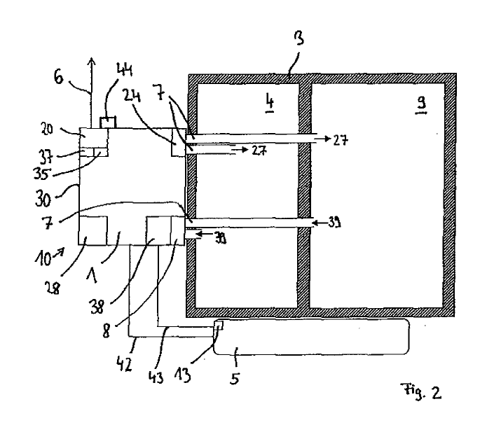

FIG. 2 an evaporator of a refrigerated vehicle according to the invention depicted as a diagrammatic sectioned view;

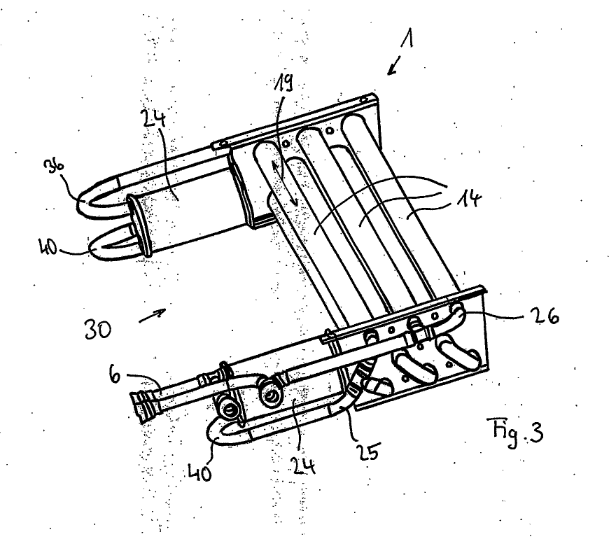

FIG. 3 an evaporator for the refrigerated vehicle according to FIG. 1 depicted as a three-dimensional perspective view;

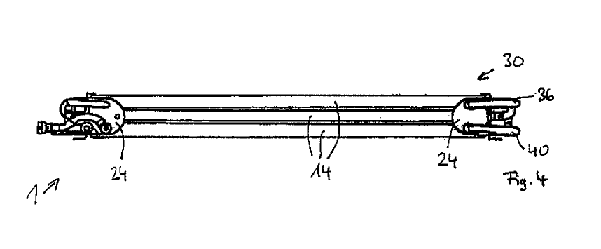

FIG. 4 a side view of the evaporator according to FIG. 3;

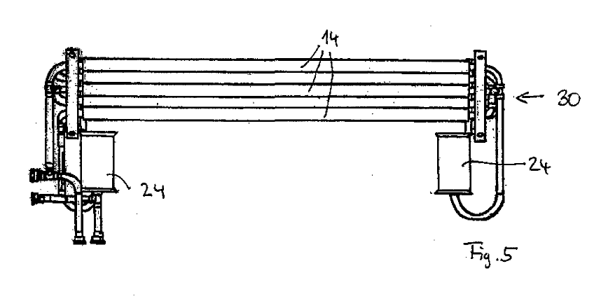

FIG. 5 a top view of the evaporator according to FIGS. 3 and 4;

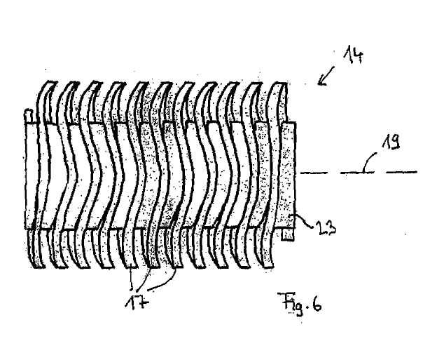

FIG. 6 a pipe of the evaporator according to FIG. 3 depicted as a top view;

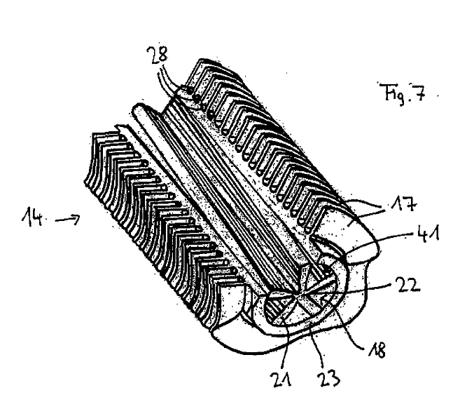

FIG. 7 a sectioned view of a perspective representation of the pipe according to FIG. 6;

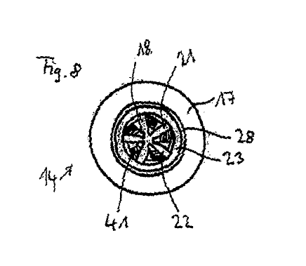

FIG. 8 a cross section of the pipe according to FIGS. 6 and 7;

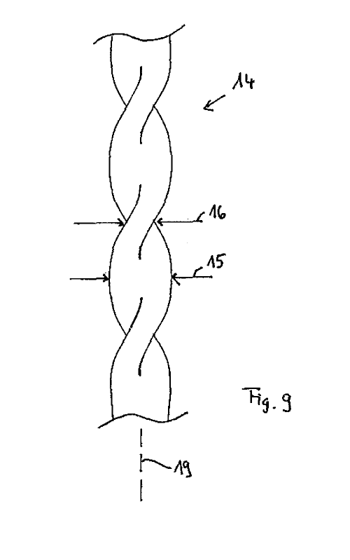

FIG. 9 an additional pipe for an evaporator of a refrigerated vehicle according to the invention depicted as a side view;

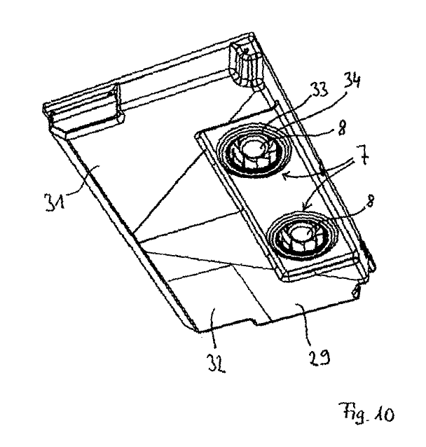

FIG. 10 a housing for a heat exchanger depicted as a perspective oblique view;

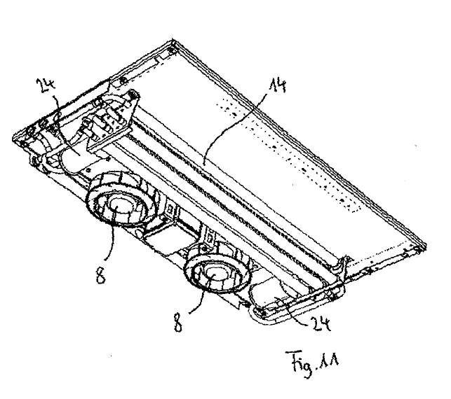

FIG. 11 a refrigeration module of the kind that can be used, for example, in a refrigerated vehicle according to FIG. 1 depicted as a perspective three-dimensional oblique view in the opened form; and

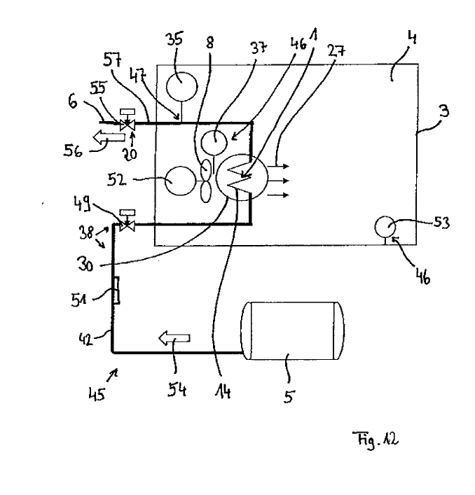

FIG. 12 a pressure generation system according to the invention or a leakage testing system according to the invention.

FIG. 1 depicts a refrigerated vehicle 2 according to the invention as a side view with a refrigeration module 10, which is installed in an upper area on a face 50 of the refrigerated vehicle 2. The refrigeration module 10 comprises an evaporator 1 and heat exchanger 30 (see FIG. 2), which is supplied with liquefied gas from a thermally insulated tank 5. The tank 5 exhibits a jacket for thermal insulation, preferably a vacuum jacket or even a foam jacket, and is connected in a fluid-conducting manner to the refrigeration module 10. The tank is mounted in a lower area 12 of the refrigerated vehicle 2.

FIG. 2 depicts an evaporator 1 arranged outside a refrigerated chamber 4, 9, which evaporator constitutes part of a heat exchanger 30, in order to liberate the cold arising from the vaporization of liquefied gas to a cooling air for cooling 39 taken in from the refrigerated chambers 4, 9. The goods (not shown here) stored in the refrigerated chambers 4, 9 are cooled with the refrigerated cooled air 27. The evaporator 1 is connected in a fluid-conducting manner to the tank 5 by a line 42 for liquefied gas. The exhaust gas that is vaporized and heated in the evaporator 1 is released into the environment via an exhaust pipe 6. The tank 5 is arranged beneath the evaporator 1. The tank 5 stores liquefied nitrogen at a temperature of around 80 Kelvin at a slight positive pressure. The positive pressure inside the tank 5 is used to bring liquefied gas from the tank 5 into the evaporator 1. In the event of the removal of large quantities of gas from the tank 5, and in order to cause pressure to build up inside the tank 5 after filling the tank 5 with liquefied gas, a pressure build-up means 13, preferably a tank heating arrangement, is provided inside the tank, by means of which the liquefied gas can be locally heated and vaporized. The control valve for the pressure build-up means 13 is connected in an electrically conducting manner via a line 43 to a pressure controller 38 on the refrigeration module 10. The pressure inside the tank 5 is regulated with the help of the pressure controller 38. The refrigerated chamber 4 is configured for frozen products and exhibits a temperature between −25 and −18° C. It is also possible, for example, for significantly lower temperatures (−60° C.) to be present. The refrigerated chamber 9 is configured for fresh products and exhibits a temperature between +4 and +12° C. The cooling air is conveyed by means of a ventilator 8 between the refrigerated chambers 4, 9 and the heat exchanger 30 arranged outside the refrigerated chambers 4, 9, for which purpose the refrigerated chambers 4, 9 are connected to the heat exchanger 30 in a fluid-conducting manner via flow channels 7. The refrigerated chambers 4, 9 are surrounded by a refrigerated chamber housing 3. The refrigerated chamber housing 3 provides thermal insulation. The refrigeration module 10 is arranged outside the refrigerated chamber housing 3, which in this case is rectangular in form. The refrigeration module 10 is also thermally insulated.

The refrigeration module 10 exhibits a phase separator 24, through which a component of the liquefied gas that has not been vaporized in the evaporator 1 can be separated from the vaporized gas component. The separated and non-evaporated liquid component is then returned to the evaporator 1. The heat exchanger 30, or to be precise the evaporator 1 exhibits a resistance heating means 28, with which any ice formed on the evaporator 1 or inside the heat exchanger 30 can be defrosted. Defrosting of the ice can also be effected, alternatively or in addition to operating the resistance heating 28, by recirculating the air from the refrigerated chamber 4. In this case, the air is cooled with the specific heat from the ice and the heat exchanger 30 and the enthalpy of melting. Recirculation does not, in fact, result in a thermal input into the refrigerated chambers 4, 9. This is also true of a refrigerated chamber that is operated at a temperature below zero degrees Celsius, if the air comes from a refrigerated chamber that is operated at a temperature above the freezing point of water and is returned to it. This is possible because the flow channels 7 can be closed during defrosting, so that the refrigerated chamber 4, 9 and the associated heat exchanger 30 are thermally disconnected. Particularly energy-efficient defrosting of the evaporator 1 or the heat exchanger 30 is enabled in this way. The refrigeration module 10, or to be precise the evaporator 1 or the heat exchanger 30, additionally exhibits a means 20 for testing the gas tightness of the cooling system and in particular of the heat exchanger 30 and the evaporator 1. Provided for this purpose at various points in the evaporator or in the heat exchanger 30 are pressure sensors 35 and temperature sensors 37, with which the time profile of the pressure and the temperature in the heat exchanger 30 and the evaporator 1 is determined. It is possible in this way to establish in particular whether a positive pressure remains stable in a closed section of the line in the evaporator 1 or the heat exchanger 30, or whether it falls over time due to leakage. With the help of the temperature sensors, it is possible to establish whether a liquid phase is present in the heat exchanger 30 or in the evaporator 1. Testing of the gas tightness can be carried out at night, for example, when the refrigerated vehicle 2 is stationary. This allows high accuracy of the measurement concerned to be achieved advantageously.

FIG. 3 depicts the evaporator 1 as a perspective view at an angle with pipes 14, in which the liquefied gas is vaporized, and over the external surface of which the cooling air for cooling 39 flows. The pipes 14 exhibit a longitudinal axis 19, at least in segments. Provided on the evaporator 1 are phase separators 24, through which a non-vaporized component of the liquefied gas flowing through the pipes 14 can be separated from the vaporized gas and returned to the pipes 14. An inlet side 26 for the pipes 14 is arranged geodetically lower than an outlet side 25 for the pipes 14. A return line 40 for the phase separator 24 is arranged beneath a supply line 36 for the phase separator 24. A catch tank 31 (see FIG. 10) to catch meltwater during a defrosting sequence is provided below the evaporator 1. The pipes 14 can be folded, helically coiled and wound in meandering form in order to ensure a particularly compact design of the heat exchanger 30 or the evaporator 1.

FIG. 4 depicts the heat exchanger 30 according to FIG. 3 as a side view. FIG. 5 depicts the heat exchanger 30 as a top view.

FIG. 6 depicts a detailed view of the pipe 14 as a top view. The pipe 14 extends along the longitudinal axis 19. The pipe 14 exhibits fins 17 at its periphery, which are pressed directly from the pipe body by a special process—that is to say, they actually represent a workpiece with the pipe 14. The fins 17 can be welded to a pipe wall 23 of the pipe 14. The pipe 14 and the fins 17 are made in particular of copper. A particularly efficient transfer of heat from the cold arising in conjunction with the vaporization and heating of the liquefied gas to the cooling air for cooling 39 is achieved with the help of the fins 17. The fins 17 are undulating in order to increase the surface area per unit of volume, and in order to generate turbulences in the cooling air for cooling 39, as a result of which the liberation of cold and the transfer of cold are increased.

FIG. 7 depicts a sectioned view of the pipe 14 according to FIG. 6 as a three-dimensional perspective view. The pipe 14 exhibits a pipe wall 23, around which the undulating fins 17 are arranged, and to which the fins 17 are attached. The fins 17 can be soldered to the pipe wall 23. In order to simplify defrosting of the fins 17, a resistance heating means 28 is provided between the fins 17. The resistance heating means 28 is constituted by a plurality of electrically insulated wires, which are heated by the effect of an electric current. Elements 18 for the generation of flow turbulences or for the radial separation of liquefied and vaporized gas are introduced into the interior of the pipe 14. The elements 18 are envisaged as baffles 21 and can be inserted into the pipe 14 as a star-shaped profile rod 22. The baffles can be soldered or welded in particular to the pipe wall 23. The profile rods 22 in the pipes 14 are transposed along the longitudinal axis 19. The thickness of a vapour layer formed between the pipe wall 23 and a drop of liquid of the liquefied gas is reduced in this way. The transposition causes the liquefied gas to be forced against the inside of the wall 23 of the pipe as it flows through the pipe 14. The elements 18 also exhibit swirl structures 41, which help to impart swirling to the liquefied gas in the pipe 14. The swirling phenomena in the pipe 14 lead to a reduction in the thickness of the vapour layer between the liquefied gas and the wall 23 of the pipe, as a result of which the efficiency of the transfer of cold from the liquefied and warming gas to the cooling air for cooling 39 is increased. The baffles can be made of a material other than the wall 23 of the pipe, for example the baffles can be made of plastic. It is advantageous if the baffles 21 are produced from a material with high thermal conductivity and are connected to the wall 23 of the pipe in such a way as to ensure high thermal conductivity. Heat transfer resistance between the baffles 21 and the wall 23 of the pipe can be reduced, for example, by soldering or welding. The lowest possible resistance to thermal transfer is advantageous with a view to ensuring the most efficient possible transfer of the cold contained in the liquefied gas to the fins 17.

FIG. 8 depicts a cross section through the pipe 14 according to FIGS. 6 and 7 as a sectioned view perpendicular to the longitudinal axis 19. The elements 18 are present as transposed, star-shaped baffles 21, which are inserted in the form of profile rods 22 into the interior of the pipe 14. The cross sections of the profile rods 22 are executed as a star with five radial arms, which are soldered to the wall 23 of the pipe. The individual radial arms exhibit swirl structures 41, which are formed by undulations or surface roughness on the profile rods. The turbulence inside the pipe 14 is increased both by the baffles as such, and by the swirl structures 41 on the baffles 21, as a result of which an improved transfer of cold from the liquefied gas to the fins 17, and thus to the cooling air for cooling 39, is achieved.

FIG. 9 depicts a further embodiment of a pipe 14, in which no fins 17 are shown in the interest of greater clarity. This embodiment is concerned with a transposed flat pipe, where the pipe 14 exhibits an internal pipe cross section which varies along the length of the pipe 14. The internal cross-sectional surface of the pipe 14 is preferably round, elliptical or strongly elliptical and is twisted along the length of the pipe 14. In particular, the surface of the projection of a first internal cross section of the pipe at a first pipe location 15 onto a second internal cross section of the pipe at a second pipe location 16 is less than 30% of the surface of the internal cross section of the pipe. The two pipe locations 15, 16 are displaced by 100 mm along the longitudinal axis 19 in this case. A centrifugal separation of the liquid (external) and the gas (internal) is produced by the twisting of the flat pipe in conjunction with the flow through the pipe 14, which intensifies the thermal contact between the liquefied gas and the wall 23 of the pipe.

Whereas baffles 21 are provided in the interior of pipes 14 in order to generate turbulences in the pipe 14 in the embodiment according to FIG. 7, the pipe as such is profiled in the embodiment according to FIG. 9, in particular being transposed or undulating, in order to generate a turbulence in conjunction with the flow.

FIG. 10 depicts a heat exchanger housing 29 for the heat exchanger 30, which is conceived as a catch tank 31 for installation internally in the heat exchanger 30, in order to catch the dripping meltwater in conjunction with defrosting and to lead it away via a drain channel (not shown). The catch tank 31 can exhibit additional heating elements 32, with which ice can be defrosted. The heat exchanger housing 29 exhibits flow channels 7 for the cooling air for cooling 39 or the refrigerated cooling air 27. The heat exchanger housing 29 in this case exhibits discharge openings 33, which include edges 34, by means of which the liquid water produced during defrosting can be arrested, so that it is not blown into the refrigerated chamber 4, 9 by the fan. Icing-up of the flow channels 7 by meltwater is prevented particularly effectively by this means. The arresting edges can be in the form of skirts, labyrinth structures or deflector plates, for example.

FIG. 11 depicts the refrigeration module 10 of the kind that can be used, for example, in a refrigerated vehicle according to FIG. 1 as a perspective three-dimensional oblique view in the opened form. A particularly compact design is achieved through the modular arrangement of the ventilators 8, the phase separators 24 and the pipes 14.

FIG. 12 depicts schematically a cooling system according to the invention with a pressure control means 38 for the purpose of conveying liquefied gas from the tank 5 into the evaporator 1 without resorting to the use of a motorized pump. The cooling system exhibits a means 20 for testing the gas tightness of the cooling system 45, the heat exchanger 30 or the evaporator 1. The evaporator 1 is connected to the tank 5 in such a way as to permit a flow via the line 42 for liquefied gas. Liquefied gas is forced into the line 42 in a direction of flow 54 of the liquefied gas by a pressure arising in the tank 5. In order to increase the pressure in the tank 5, the line 42 is closed by means of a valve 49, in conjunction with which a component of liquefied gas in the line 42 is caused to vaporize upstream of the valve 49, that is to say between the valve 49 and the tank 5, by warming of the line 42. The valve 49 is also designated as an inlet valve. The line 42 can exhibit thermal insulation, such as dual-wall vacuum insulation (super-insulation) or a foam jacket. As a general rule, the thermal input is great enough, in spite of this thermal insulation, to vaporize a sufficiently large component of liquefied gas in the line 42 upstream of the valve 49, and to increase the pressure in the tank 5. In specific cases, it may be appropriate to provide a thermal bridge 51 in the line 42 upstream of the valve 49, which bridge takes care of the necessary thermal input. The thermal bridge 51 can be formed by a reduction in the insulation on the line 42, in conjunction with which the thermal bridge is provided in particular on a section of the line 42 and is advantageously arranged in a variable manner in respect of a heat transfer coefficient. The valve 49 is opened in pulses, causing liquefied gas to be forced in the direction of flow 44 into the line 42 and conveyed into the heat exchanger 30. No stationary condition occurs due to the pulsed operation of the valve 49 in the line 42, so that the temperature in the line 42 upstream of the valve 49 fluctuates laterally according to the closed condition of the valve 49 and the removal of gas from the tank 5.

In order to ensure an adequate build-up of pressure in the tank 5, the internal volume of the line 42 upstream of the valve 49 as far as the opening on the tank 5 is at least approximately 1/1,000 of the internal volume of the tank 5. The heat exchanger is arranged inside a refrigerated chamber housing 3 and liberates refrigerated cooling air 27 to the refrigerated chamber 4. For this purpose, the air inside the refrigerated chamber 4 is recirculated with the help of a ventilator 8, which is driven by a motor 52. Inside the refrigerated chamber 4, an initial temperature sensor 37 is provided at a first point 46, in order to determine temperature fluctuations. If the temperature inside the refrigerated chamber 4 falls abruptly at a rate of more than 5° C. per minute, an initial warning signal is given, which draws the attention of the operator of the refrigerated vehicle 2 to the possible presence of a leak in the cooling system 45. An additional temperature sensor 53, which serves the same purpose, can be provided inside the refrigerated chamber 4 at an additional first point 46.

The motor 52 can be operated as an electric motor or pneumatically utilizing the vaporized gas. The liquefied gas is conveyed downstream of the valve 49 through the evaporator 1 and the heat exchanger 30 as far as an additional valve 55. The vaporized gas is then released into the environment as exhaust gas 56 via the exhaust pipe 6. The line section 57 of the line 42 between the valve 49 and the additional valve 55 can be closed off with the help of the two valves 55, 49. It is possible in this case in particular to enclose a positive pressure if the line section 57 is gastight. Provided on the line section 57 at a second point 47 is a pressure sensor 35, which registers the time profile of the pressure in the line section 57. If a positive pressure enclosed between the valves 55, 49 falls below a set value, or if the positive pressure varies more rapidly than a set reference value, for example more rapidly than 0.2 bar per minute, a second warning signal will be given. The first warning signal and the second warning signal are indicated to the driver of the refrigerated vehicle 2 on an indicator instrument 44 (see FIG. 2). The valve 49, the additional valve 55, the pressure sensor 35 and the temperature sensors 37 and 53 constitute the means 20 for testing the gas tightness of the heat exchanger 30, the evaporator 1 and the cooling system 45. The additional valve 55 is also designated as an exhaust valve.

Use is made advantageously of at least two heat exchangers 30 and at least two evaporators 1, which defrost and cool alternately. Greater operating reliability is achieved in this way. Energy costs, which arise as a result of an active defrosting process in the event of ice formation on the heat exchanger 30 and on the evaporator 1, are also reduced significantly by this means.

A homogeneous material pairing should be used for the choice of material of the heat exchanger. Heat exchangers made of aluminium or copper have proven themselves in service in low-temperature engineering. For production engineering reasons, a homogeneous choice of materials consisting of copper pipes and copper fins is preferably selected, although other suitable materials can be used. Heat exchanger pipes are used in this application preferably as ribbed pipes, which consist homogeneously of copper and possess copper fins on the outer envelope surface. These can be soldered, welded, clamped or attached to or installed on the outer envelope surface by other methods. The fins 17 are preferably pressed from the pipe material by rolling processes and are then provided with an undulation on the lateral surface. This fin undulation is produced in the final rolling operation. In the event of a transverse laminar flow through the pipe, the undulating form produces a turbulent airflow between the fins 17, which manifests itself positively on the air side as higher heat transfer coefficients. The rolled fins 17 preferably run along the periphery in the form of a screw with a distance between the fins of between 2 and 10 mm, and preferably 3 mm. Other distances between the fins can be used, however. The pipes 14 provided with fins 17 are preferably held in end fins. The expression end fin is understood to denote a plate provided with holes, through which the pipe connections of the pipe lines are passed. Around the holes, slots are drawn through the end fins in such a way that the pipes are able to move individually in each case in relation to the attachment points of the end fin. The pipe ends preferably project beyond the end fins. The end fins, which preferably consist of copper, and the pipe connections of the ribbed pipes are securely attached to the end fins, preferably by soldering. The pipe ends of the pipes 14 provided with fins projecting from the end fins are connected to one another with copper pipes or bridges.

In the initial phase of the transmission of heat from the liquid nitrogen to the pipes, a phase transition from the liquid to the gaseous physical condition takes place in the heat exchanger pipes. During this change in physical condition, a liquid-vapour mixture reaction takes place through film and nucleate boiling. Experience shows that high accelerations of the liquid due to vapour bubbles formed in the direction of flow ahead of the liquid occur as the result of nucleate boiling inside pipes.

In previously disclosed evaporators 1, the resulting small vapour bubbles are combined into large vapour bubbles in fractions of a second and propel the column of liquid in front of them through the heat exchanger pipe at an explosive rate as a result of the change in volume. In previously disclosed heat exchangers, only an inadequate transmission of heat from the liquefied gas to the wall 23 of the pipe takes place through this process.

In the heat exchanger 30, elements are installed inside the pipe 14, which permit the most uniform vaporization possible inside the heat exchanger pipes and increase the heat transfer coefficients in this way. In order to achieve this optimization, flow profiles or baffles 21 are inserted inside the pipes 14, which ensure that the liquid always flows on the internal surface of the pipe wall 23. Profile rods 22 are used, for example, which divide the pipe cross section longitudinally into n sections. These sections are executed as circle segment profiles, in which the angle of the circle segment begins at the centre of the pipe and extends to the envelope surface. It is also possible to use other geometries, although these should only form the largest possible spatial volume on the inside of the pipe envelope. Preferably five radial internal profiles in the form of an internally located star are used. This star is twisted about the longitudinal axis. As already mentioned, at the time of entering the heat exchanger pipe, the liquefied nitrogen experiences acceleration due to the vapour bubbles that are formed and the change in volume resulting therefrom. The twisting or transposition of the profile rod 22 with n radial arms about the longitudinal axis 19 causes flow channels to be produced in the pipe 14, which channels exhibit the form of a coil internally along the envelope surfaces of the wall 23 of the pipe. A transposition of the internal profile with n radial arms can be undertaken as required about the longitudinal axis 19 in relation to a length of the pipe 14. However, channels must still be present in the pipe after the twisting. The internal part is twisted between two times and ten times, and preferably three times per metre about the longitudinal axis 19. Twisting of the profile rod 22 with n radial arms presses the fluid that is caused to accelerate by centrifugal forces against the internal envelope surface and conveys it along the pipe. As a result of the difference in temperature between the liquid and the internal envelope surface, the physical condition of the liquefied nitrogen is changed by nucleate boiling. The heat transfer coefficients are increased significantly in this way. The liquefied gas can be almost entirely vaporized after a comparatively short distance.

All the pipes 14 present in the heat exchanger can be charged with liquid nitrogen. Preferably two pipes 14 are charged with liquefied nitrogen. The ribbed pipes of the heat exchanger that are charged with liquid nitrogen are preferably the uppermost pipes in the geodetic sense. The two highest pipes in the geodetic sense on the air outlet side are preferably used for the purpose of charging with fluid. In this way, a counterflow between the air flow for cooling and the flow of nitrogen is superimposed on the transverse flow.

A phase separator 24 is advantageously connected downstream of the ribbed pipes 14 charged with fluid with a twisted star situated internally. The phase separator 24 collects any drops of liquid that have not been vaporized, which have not come into contact or have made only inadequate contact with the internal envelope surface. The phase separators are preferably configured as a horizontal pressure vessel. An inlet pipe is preferably routed for a short distance beneath the geodetically upward-facing envelope surface through the end face. The outlet pipes are present on the opposite side of the inlet pipe, and an outlet pipe is preferably routed geodetically for a short distance above the further subjacent envelope surface through the end face.

The task of the phase separator 24 is to collect the entrained liquid components and to convey them back to the heat exchanger through the subjacent outlet pipe of the following pipe (ribbed pipe) exhibiting fins. Any collected liquid nitrogen that remains unvaporized is preferably conveyed back to the two ribbed pipes, which are present at the lowest point in the geodetic sense on the air outlet side.

The downstream ribbed pipes 14 with a twisted internally situated profile rod 22 serve as pre-heaters for the gaseous nitrogen. N pipes can be connected downstream, in order to heat the gaseous nitrogen up to the stipulated exhaust gas temperature. Preferably six pipes are used as pre-heaters, in which case the two return pipes from the phase separator are also counted as pre-heaters.

The heat exchanger can preferably also be operated only as a pre-heater. For this purpose, the gas temperature at the inlet should lie significantly below the air inside the chamber to be refrigerated.

A means of resistance heating is provided, since it is not possible, for process engineering reasons, for a heat input for defrosting to be taken from the interior of the pipe 14. This defrosting heating can disperse any icing-up. In particular the fluctuations in temperature from −196° C. to +100° C. arising in this case require the heating and the pipes to possess special characteristics. An electrical heating means is required for defrosting, preferably with at least 2 to 40, and for example 9, silvered copper strands, which in each case can exhibit a diameter of 0.1 mm to 0.5 mm, for example 0.25 mm. The copper strands are contained in a sheath made of polymer, such as polytetrafluoroethylene (PTFE), to provide electrical insulation. The silvered copper strands with a PTFE sheath are wound helically between the fins 17 as far as the base of the ribbed pipe, so that contact is established between the heating cable and the copper of the ribbed pipe between each fin 17 and the base of the fin. Uniform heat distribution for defrosting is possible in this way on the whole of the heat exchanger.

In order to achieve targeted routing of the airflow over the entire heat exchanger, a heat exchanger housing 29 is designed as a covering hood, which on the one hand functions as a catch tank 31 for condensate water, and on the other hand assures the routing of the airflow inside the heat exchanger 30. In addition, the heat exchanger housing 29 also determines the air extraction direction. The air extraction direction is set, as necessary, on the front or optionally to the left, to the right or simultaneously to the left and to the right, by the expedient of providing reference breaking points in the hood of the heat exchanger such that parts of the hood which point in the desired air extraction direction can be readily broken open. A heat exchanger housing made of plastic, for example a plastic of the polystyrene/polyethylene material pairing, is preferably selected because of the large differences in temperature. This material pairing is characterized by its small thermal deformation. Moreover, the material can be readily formed and offers the possibility of internal insulation in order to avoid condensate on the outside.

The heat exchanger and, to be precise, the evaporator is advantageously equipped with a device for optimizing the transmission of heat for the vaporization of liquefied gases, and in particular for low-temperature liquefied nitrogen, which serves as an air cooler, in conjunction with which the heat exchanger and in particular the evaporator consists of ribbed pipes with rolled, undulating fins running round in the form of a screw. In this case, the material pairing of the heat exchanger pipe and the fins in particular consists of a homogeneous metal. The homogeneous material can be copper. Inside the ribbed pipes in particular, a flow profile is used which divides the cross section of the pipe longitudinally into n sections, in conjunction with which these sections can be executed as circle segment profiles, and/or the angle of the circle segment begins at the centre of the pipe and can extend as far as the envelope surface. Other geometries can also find an application here, which advantageously constitute the largest spatial volume on the inside of the pipe envelope. It is advantageous to use internal profiles with multiple radial profiles, and in particular five radial profiles, in the form of an internally located star profile. There is a particular preference to transpose the profile situated inside the ribbed pipe about the longitudinal axis, as a result of which helical channels, which taper towards the centre of the pipe, are formed inside the pipe. The flow profile present inside the ribbed pipe can divide the cross section of the pipe at least once. Advantageously, the flow profile present inside the ribbed pipe, which divides the pipe cross section at least once, is twisted helically in such a way that at least two helical fluid channels are formed inside the pipe. The pipes that are charged with liquid nitrogen are advantageously the geodetically uppermost pipes on the air outlet side. The ribbed pipes are advantageously soldered in each case on a copper end fin on either side. A horizontal phase separator 24 can be formed and/or welded on the end fin in each case as a pressure container. The inlet pipe into the phase separator 24 can be introduced into the phase separator in the upper area of the end surface, at a short distance below the envelope surface of the pressure container. The outlet pipe can be routed from the phase separator in the lower area of the end surface, at a short distance above the envelope surface of the pressure container. The plastic part of the heat exchanger can be made from a thermoplastic plastic (preferably polyethylene, PE) in a compression mould or a drawing mould. A material pairing of polystyrene/polyethylene is advantageous in view of the high temperature differences and the need for insulation.

Various additional aspects that are closely associated with the invention are described below. The individual aspects can be applied individually in each case, that is to say independently of one another, or can be combined with one another as required. These aspects can also be combined with the previously described aspects.

A particularly advantageous mobile refrigerated vehicle 2 in terms of its operating reliability, dependability and energy-efficiency comprises a refrigerated chamber housing 3 for at least one refrigerated chamber 4 contained therein, a tank 5 for liquefied gas, an evaporator 1 for vaporizing the liquefied gas while liberating cold to the refrigerated chamber 4, and an exhaust pipe 6 for the vaporized gas, the evaporator 1 being arranged outside the refrigerated chamber 4. The liberation of the cold from the evaporator 1 takes place advantageously to refrigerated air, which is conveyed via flow channels 7 from the refrigerated chamber 4 to the evaporator 1, and from the evaporator 1 to the refrigerated chamber 4. Provided in particular for this purpose is a ventilator 8, which is arranged outside the refrigerated chamber 4, in conjunction with which the ventilator 8 and the evaporator 1 can be attached as a refrigeration module 10 on the refrigerated vehicle 2. The refrigerated vehicle 2 exhibits in particular at least one first refrigerated chamber 4 for temperatures below 0° C., and in particular below −10° C., and at least one second refrigerated chamber 9 for temperatures above 0° C., and in particular between +4 and +10° C. The evaporator 1 can be arranged in an upper area 11, in particular on the roof or on the face, of the refrigerated vehicle 2. The tank 5 can be arranged in a lower area 12 of the refrigerated vehicle 2, in particular underneath the refrigerated vehicle 2. Provided on the tank 5 is in particular a pressure control 38, in particular with a pressure build-up means 13, for example a resistance heating means, through which the liquefied gas is forced into the evaporator 1. A means 20 for testing the gas tightness of the cooling system, and in particular the evaporator 1, is advantageously provided. The necessary heating energy can be taken from the environment.

An advantageous method for refrigerating a refrigerated chamber 4 of a mobile refrigerated vehicle 2 comprises the following process stages: removal of a liquefied gas from a tank 5 and supply of the gas into an evaporator 1 arranged outside the refrigerated chamber 4; removal of a flow of cooling air for cooling from the refrigerated chamber 4; evaporation of the liquefied gas in the evaporator 1 and utilization of at least a part of the cold component for the refrigeration of the flow of cooling air; introduction of the refrigerated flow of cooling air into the refrigerated chamber 4.

With regard to questions of a safety-related nature, and also for reasons of technical efficiency, an advantageous first method for monitoring the gas tightness of a cooling system 45 of a refrigerated vehicle 2 includes the following steps: recording a time profile of the temperature at least a first point 46 in the cooling system 45, and determining any change in the temperature at the first point 46 within a first time interval; comparison of the change with a first reference value and triggering of a first warning signal, if the change exceeds the first reference value. With regard to questions of a safety-related nature, and also for reasons of technical efficiency, an advantageous second method for monitoring the gas tightness of a cooling system 45 of a refrigerated vehicle 2 includes the following steps: subjecting a line section 57 of the cooling system 45 to a positive pressure; blocking this line section 57; recording a time profile of the pressure at least a second point 47 in the line section 57, and determining any change in the pressure at the second point 47 within a second time interval; comparison of the change with a second reference value and triggering of a second warning signal, if the change exceeds the second reference value, in conjunction with which in particular the method is repeated after a time delay if the pressure increases. An additional warning signal is given advantageously if the pressure lies below a set minimum pressure. It is advantageous in this case to combine the first method with the further method, in conjunction with which the further method in particular is implemented if the first warning signal is triggered. The first reference value corresponds advantageously to a fall in temperature of not more than 20° C. per minute, and in particular not more than 10° C. per minute, for example not more than 5° C. per minute. The second reference value corresponds in particular to a fall in pressure of not more than 1 bar per minute, and in particular not more than 0.5 bar per minute, for example not more than 0.2 bar per minute. For a rough test, the first and/or the second time interval exhibits, for example, a duration of between 1 second and 300 seconds, in particular between 50 and 180 seconds, for example between 10 and 60 seconds. For a fine test, the second time interval exhibits, for example, a duration of between 5 minutes and 24 hours, in particular between 30 minutes and 12 hours, for example between 1 hour and 4 hours. The monitoring of the gas tightness can be initiated by turning off the refrigerated vehicle 2. The first and/or second warning signal can be indicated optically and/or acoustically with an indicator instrument 44. Monitoring is initiated and/or carried out in particular during a defrosting phase of the cooling system 45.

It is possible, alternatively or additionally, to monitor the gas tightness of a cooling system 45 according to a method which comprises the following consecutive steps:
a) closing a valve 49 between a tank and at least one of the following elements: a heat exchanger 30 and an evaporator 1 with the at least chronologically identical opening of an additional valve 55, via which a flow-related connection to an exhaust pipe 6 can be produced, and measuring the pressure between the valve 49 and the additional valve 55;
b) closing the additional valve 55, and measuring the pressure between the valve 49 and the additional valve 55; and
c) opening the valve 49, and measuring the pressure between the valve 49 and the additional valve 55.

In the case of an intact valve 49 and an intact additional valve 55—assuming an essentially constant temperature—in step a), the measured pressure should correspond to the ambient pressure outside the cooling system, usually atmospheric pressure. In step b), the measured pressure should be constant over time, whereas in step c), an increase in pressure up to an equilibrium pressure and then an essentially constant pressure should be measured. These pressures can be compared in particular with reference values that are capable of being set, in order to enable faulty operation of the valves 49, 55 to be detected.

A particularly advantageous method for operating a cooling system 45 of a refrigerated vehicle 2, having at least one refrigerated chamber 4, 9, comprises at least one of the two methods for testing the gas tightness of the cooling system 45, in conjunction with which in particular the cooling system 45 exhibits a ventilator 8, and the ventilator 8 is switched on when a door 48 of the refrigerated chamber 4, 9 is opened.

A particularly advantageous cooling system 45 for a refrigerated vehicle 2 comprises at least one tank for liquefied gas, at least one evaporator 1 and one means 20 for testing the gas tightness of the cooling system 45 with at least one temperature sensor 37 and/or at least one pressure sensor 35 for performing at least one of the two methods for testing the gas tightness of the cooling system 45, in conjunction with which in particular a refrigerated chamber 4, 9 is provided with a door 48 and a ventilator 8, and the ventilator 8 is set operating as soon as the door 48 is opened. In particular, the ventilator 8 is set operating when a gas leak is detected and the door 48 of the refrigerated chamber 4, 9 is opened.

A particularly advantageous refrigerated vehicle 2 includes the cooling system 45 described above.

A particularly advantageous method for generating a positive pressure in a tank 5 for liquefied gas in a refrigerated vehicle 2 with an evaporator 1 for the liquefied gas, where the evaporator 1 is connected to the tank 5 in a fluid-conducting manner via a line 42 for liquefied gas, and where a valve 49 is arranged in the line 42, comprises the following process steps: opening the valve 49 and permitting liquefied gas to pass from the tank 5 into the line 42; closing the valve 49 in such a way that a component of the liquefied gas remains in the line 42 and is able to flow back into the tank 5; heating the component in the line 42. In this way, heat/energy is introduced into the tank, where it leads to an increase in pressure. The line 42 is preferably heated in such a way that the component present therein is vaporized at least partially. Highly efficient operation of the refrigeration process and the refrigerated vehicle without the use of a motorized pump is possible with this procedure. At the time of closing the valve 49 in the line 42 upstream of the valve 49, a volume of liquefied gas of at least 1/1500, in particular at least 1/700 and, for example, at least 1/300 of the volume of the tank 5 is advantageously enclosed. The process of heating causes the vaporization of in particular at least 10%, in particular at least 20% and, for example, at least 50% or at least 80% of the liquefied gas component remaining in the line 5. Heating can be performed on the line 42 by means of environmental heat.

A particularly advantageous method for conveying liquefied gas from a tank 5 into an evaporator 1 of a refrigerated vehicle 2 situated at a geodetically higher point, where the evaporator 1 is connected to the tank 5 via a line 42 for liquefied gas in such a way as to permit a flow, and a valve 49 is arranged in the line 42, comprises the following steps: building up a positive pressure in the tank by the method for building up a pressure according to the invention, and opening the valve 49 and permitting the liquefied gas to be forced into the evaporator 1 by the positive pressure. The valve 49 is opened in particular in pulses for the purpose of building up the pressure.

A particularly advantageous device for building up a positive pressure in a tank 5 for liquefied gas in a refrigerated vehicle 2 with an evaporator 1 for the liquefied gas, where the evaporator 1 is connected to the tank 5 via a line 42 for liquefied gas in such a way as to permit a flow, and where a valve 49 is arranged in the line 42, comprises a control means for implementing the method for building up a pressure according to the invention, where in particular the internal volume in the line 42 upstream of the valve 49 amounts to at least 1/1500, in particular at least 1/700 and, for example, at least 1/300 of the internal volume of the tank 5. The line 42 advantageously exhibits thermal insulation, in conjunction with which in particular the line or its insulation upstream of the valve 49 exhibits a thermal bridge 51 such that or, to be specific, a thermal capacity such that adequate heating of the liquid nitrogen present in the tank 5 can be achieved.

The device for building up a pressure according to the invention provides an advantageous cooling system 45 for a refrigerated vehicle 2 with at least one refrigerated chamber 4, 9, a tank 5 for liquefied gas and an evaporator 1 for the evaporation of the liquefied gas and the liberation of cold to the refrigerated chamber 4, 9, where the evaporator 1 is connected to the tank 5 via a line 42 for liquefied gas in such a way as to permit a flow, and where a valve 49 is arranged in the line 42.

The invention relates to a heat exchanger 30 for a mobile refrigerated vehicle 2 having a tank 5 for liquefied gas comprising a pipe 14 for receiving a flow of a liquefied gas and for the vaporization of at least one component of the liquefied gas, in conjunction with which the pipe 14, at least in sections, exhibits a longitudinal axis 19, and the heat exchanger 30 comprises an inlet side 26 for liquefied gas and an outlet side 25 for at least partially vaporized gas, and in conjunction with which the outlet side 25 is connected to an exhaust pipe 6 in such a way as to permit a flow, in conjunction with which the pipe 14 exhibits elements 18 in its interior for the purpose of generating turbulences in the flow or a radial phase separation. The invention is characterized in that, with the help of the elements 18, the thickness of a gas interface layer on a wall 23 of the pipe 14, which occurs as a result of vaporization of the gas, is reduced considerably, whereby the efficiency of the heat exchanger 30 is increased considerably.

### FOR INFORMATION PURPOSES ONLY

### List of Reference Designations

1 Evaporator
2 Refrigerated vehicle
3 Refrigerated chamber housing
4 Refrigerated chamber
5 Tank
6 Exhaust pipe
7 Flow channels
8 Ventilator
9 Refrigerated chamber
10 Refrigeration module
11 Upper area
12 Lower area
13 Pressure build-up means
14 Pipe
15 First pipe location
16 Second pipe location
17 Fins
18 Elements
19 Longitudinal axis
20 Means for testing the gas tightness of the heat exchanger 30 and the evaporator 1
21 Baffles
22 Profile rods
23 Pipe wall
24 Phase separator
25 Outlet side
26 Inlet side
27 Refrigerated cooled air
28 Resistance heating
29 Heat exchanger housing
30 Heat exchanger
31 Catch tank
32 Heating element
33 Discharge opening
34 Arresting edges
35 Pressure sensor
36 Supply line for phase separator 24
37 Temperature sensor
38 Pressure control
39 Cooling air for cooling
40 Return line for phase separator 24
41 Swirl structure
42 Line for liquefied gas
43 Electrical line
44 Indicator instrument
45 Cooling system
46 First position
47 Second position
48 Door
49 Valve
50 Face
51 Thermal bridge
52 Motor for ventilator
53 Temperature sensor
54 Direction of flow of liquefied gas
55 Additional valve
56 Exhaust gas
57 Line section

1-23. (canceled)

24. A heat exchanger for a mobile refrigerated vehicle having a tank for liquefied gas comprising at least a pipe for accepting a flow of a liquefied gas and for the evaporation of at least one part of the liquefied gas, in conjunction with which the pipe, at least in sections, exhibits a longitudinal axis, and the heat exchanger comprises an inlet side for liquefied gas and an outlet side for at least partially evaporated gas, and in conjunction with which the outlet side is connected to an exhaust pipe in such a way as to permit a flow, characterized in that the pipe exhibits elements in its interior for the purpose of generating turbulences in the flow.

25. A heat exchanger for a mobile refrigerated vehicle having a tank for liquefied gas comprising at least a pipe for accepting a flow of a liquefied gas and for the evaporation of at least one part of the liquefied gas, in conjunction with which the pipe, at least in sections, exhibits a longitudinal axis, and the heat exchanger comprises an inlet side for liquefied gas and an outlet side for at least partially evaporated gas, and in conjunction with which the outlet side is connected to an exhaust pipe in such a way as to permit a flow, characterized in that the pipe exhibits elements in its interior for the purpose of producing a radial separation of the liquid phase and the gaseous phase.

26. The heat exchanger of claim 24, wherein the elements are formed by baffles in the pipe, and in particular by profile rods or profile strips extending along the longitudinal axis.

27. The heat exchanger of claim 26, wherein the profile rods or profile strips are star-shaped, in particular with at least two jets, and preferably with at least three jets, for example at least 5 jets.

28. The heat exchanger of claim 24, wherein the baffles extend in a transposed manner along the longitudinal axis.

29. The heat exchanger of claim 24, wherein the baffles extend in an undulating manner along the longitudinal axis.

30. The heat exchanger of claim 24, wherein the pipe exhibits a pipe wall, and the pipe wall is profiled along the longitudinal axis, and is in particular undulating or transposed.

31. The heat exchanger of claim 24, wherein the pipe exhibits an internal pipe cross section which changes along the length of the pipe, and in particular the surface of the projection of a first internal pipe cross section at a first pipe location onto a second internal pipe cross section at a second pipe location is smaller than 90%, and in particular smaller than 70%, and preferably smaller than 50% of the surface of the internal cross section of the pipe.

32. The heat exchanger of claim 24, wherein the pipe exhibits rolled-out fins in particular on its outside.

33. The heat exchanger of claim 32, wherein the fins run around the periphery in the form of a screw and/or are undulating in form.

34. The heat exchanger of claim 24, wherein the pipe and the elements are produced from a homogeneous material, in particular copper, and in particular by welding or soldering.

35. The heat exchanger of claim 24, wherein the elements divide an internal cross section of the pipe into at least two, and in particular at least three, and preferably at least five internal cross sections of the pipe.

36. The heat exchanger of claim 35, wherein the internal cross sections of the pipe broaden radially towards the outside.

37. The heat exchanger of claim 24, wherein a phase separator is provided for the purpose of separating liquefied gas from evaporated gas, which is connected to the outlet side to permit a flow.

38. The heat exchanger of claim 37, wherein the phase separator is embodied as a pressure vessel.

39. The heat exchanger of claim 24, wherein the inlet side for the liquefied gas is arranged geodetically above the outlet side for the at least partially evaporated gas.

40. The heat exchanger of claim 24, wherein a resistance heating means wrapped in the form of a helix around the pipe.

41. The heat exchanger of claim 24, wherein the heat exchanger exhibits a heat exchanger housing manufactured in particular from thermoplastic material, which provides the air supply inside the heat exchanger.

42. The heat exchanger of claim 24, wherein at least one pressure sensor on the heat exchanger and a means for testing the gas tightness of the cooling system, and in particular of the heat exchanger are provided.

43. The heat exchanger of claim 42, wherein a temperature sensor is provided on the heat exchanger and is electrically connected to the means for testing the gas tightness.
